(19) United States
(12) Patent Application Publication
(10) Pub. No.: US 2011/0318591 A1
(43) Pub. Date: Dec. 29, 2011

(54) MOLDED ARTICLE AND METHOD FOR MAKING THE SAME

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/861,904

(22) Filed: Aug. 24, 2010

(30) Foreign Application Priority Data
Jun. 28, 2010 (CN) 201010211021.X

(51) Int. Cl. B32B 15/08; B29C 45/14

(52) U.S. Cl. 428/464; 264/261

(57) ABSTRACT

A molded article includes a first layer made of soft material, a second layer made of plastic material; and a third layer made of hard material. The first layer and the third layer are respectively joined to the opposite sides of the second layer by injection molding. A method for making the molded article is also disclosed.

### CROSS-REFERENCE TO RELATED APPLICATIONS

This application is related to co-pending U.S. patent applications (Attorney Docket No. US34278 and US34279), both entitled “MOLDED ARTICLE AND METHOD FOR MAKING THE SAME”, by Kun-Tsan Wu. Such applications have the same assignee as the present application. The above-identified application is incorporated herein by reference.

### BACKGROUND

1. Technical Field

The present disclosure relates to a molded article and a method for making the molded article.

2. Description of Related Art

Molded articles fabricated by injection molding are often painted for aesthetic reasons. However, paint may easily chip, peel, or wear off the molded article.

Therefore, there is room for improvement within the art.

### BRIEF DESCRIPTION OF THE DRAWINGS

Many aspects of the present molded article and method for making the same can be better understood with reference to the following drawings. The components in the various drawings are not necessarily drawn to scale, the emphasis instead being placed upon clearly illustrating the principles of the present molded article and method for making the same. Moreover, in the drawings, like reference numerals designate corresponding parts throughout the diagrams.

FIG. 1 is a sectional schematic view of part of a molded article according to a first exemplary embodiment.

FIG. 2 is a sectional schematic view during molding of the molded article.

FIG. 3 is a sectional schematic view of the molded article.

FIG. 4 is a sectional schematic view of a molded article according to a second exemplary embodiment.

FIG. 5 is a sectional schematic view of a molded article according to a third exemplary embodiment.

### DETAILED DESCRIPTION

The disclosed molded article can be a housing of electronic device, such as a mobile phone or personal digital assistant.

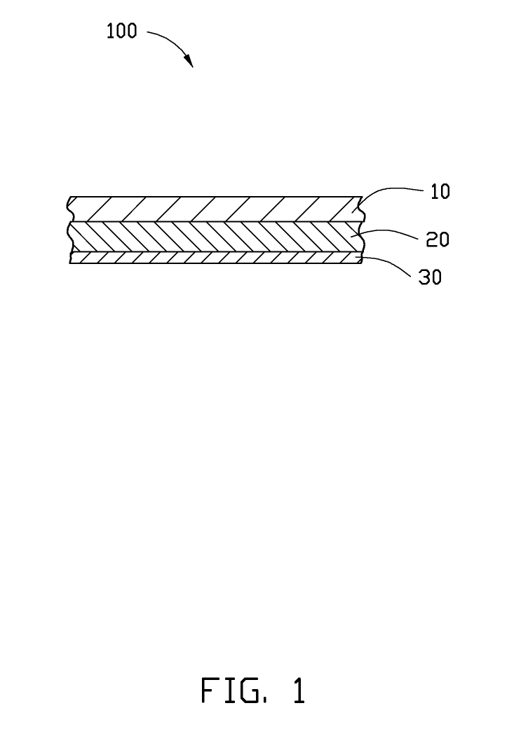

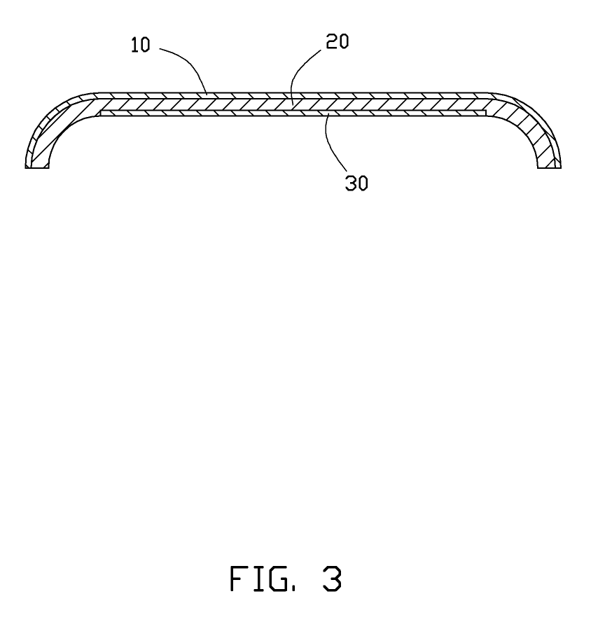

FIG. 1 shows a molded article 100 according to a first exemplary embodiment including a first layer 10, a second layer 20 and a third layer 30. For example, the first layer 10 can substantially cover the second layer 20, and the third layer 30 can be embedded into the second layer 20 (shown in FIG. 3).

The first layer 10 may be made of a soft material selected from a group including leather, textile, and film. The soft material should be wear-resistant yet soft. The second layer 20 is made of a plastic material selected from a group including polycarbonate, polymethyl methacrylate, polystyrene, or any desired combination thereof. The third layer 30 is made of a hard material selected from a group including metal, glass, and ceramic. The hard material for the third layer 30 adds mechanical strength. When the third layer 30 is made of metal, it may also function as an antenna.

The molded article 100 can be made by injection molding, that is, molding the first layer 10 and the third layer 30 to the two opposite sides of the second layer 20, respectively, and if needed, reinforcing the bond with adhesive (not shown) placed between the layers. The adhesive can be made of polyurethane, epoxy resin, or a combination of the two.

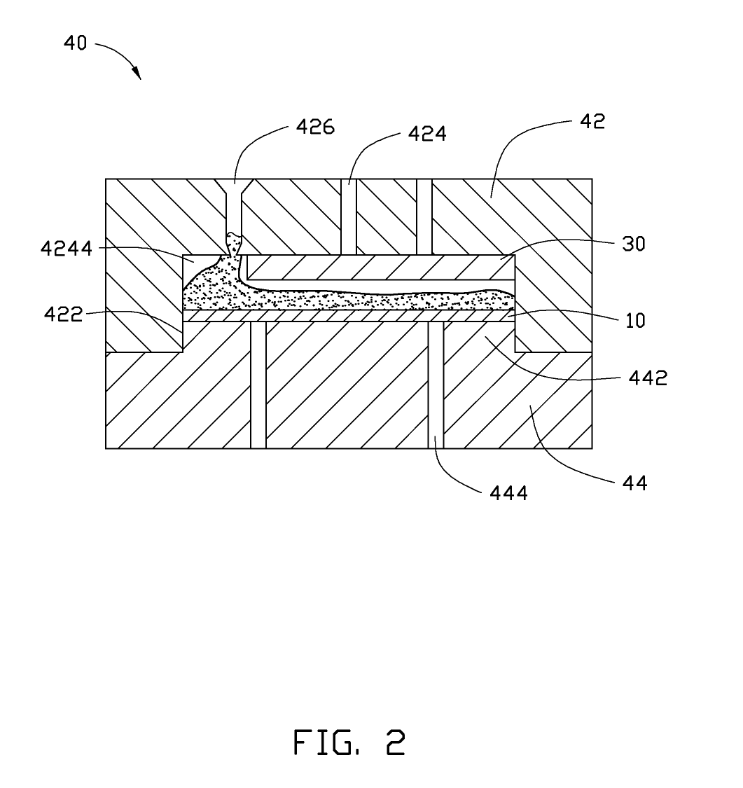

Referring to FIG. 2, to fabricate the molded article 100, the first layer 10, which can be a decorative film, for example, and the third layer 30, which can be a cooper foil, for example, are assembled into a mold 40. The mold 40 includes a female mold 42 and a male mold 44 engaging with the female mold 42. The female mold 42 defines a cavity 422, first suction holes 424, and a channel 426. The suction holes 424 and the channel 426 run through the female mold 42 and interconnect with the cavity 422. The male mold 44 forms a core 442, second suction holes 444 running through the male mold 44, and the core 442.

The first layer 10 is secured onto the core 442 by a vacuum communicating with the second suction holes 444. The third layer 30 is secured into the cavity 422 by a vacuum communicating with the first suction holes 424. The third layer 30 does not cover the channel 426. The female mold 42 engages with the male mold 44, and the core 442 extends into the cavity 422 to form a chamber 4244. Plastic molding material is injected into the chamber 4244 through the channel 426 and forms the second layer 20. The second layer 12 integrally combines with the first layer 10 and the third layer 20 to form the molded article 100, which can then be removed.

Understandably, a through hole (not shown) can be defined in the third layer 30 for injection of molten plastic into the chamber 4244 when the third layer 30 is substantially attached on the entire bottom of the cavity 422 and covers the channel 426. To increase the combining strength, the first layer 10 and the third layer 30 can be printed with adhesive thereon before molding. The adhesive adheres to the second layer 20.

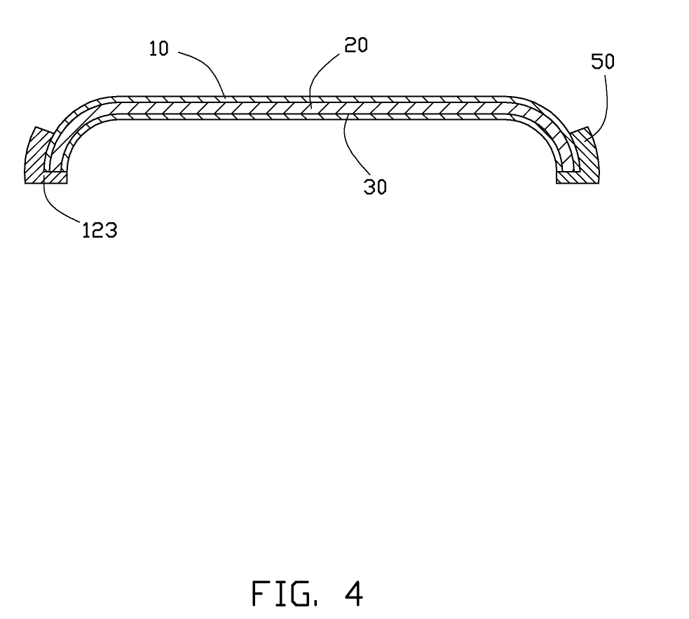

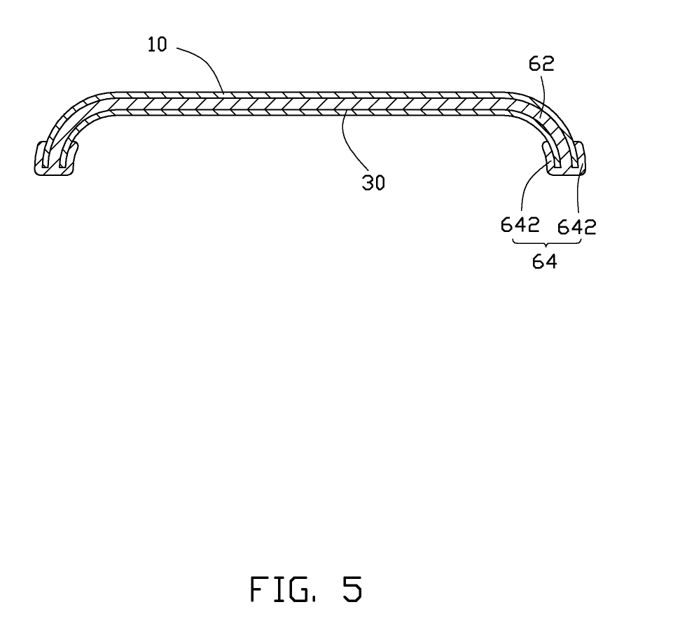

Referring to FIGS. 4 and 5, to prevent the molded article 100 from separating at the edges thereof, an additional sealing layer 50 can be formed to enclose the edges of the molded article 100 by a second injection molding step. The sealing layer 50 may have an L-shaped cross-section that extends to the first layer 10 and covers the end surface 123 of the molded article 100. During the second injection molding, the molded article 100 is placed into another mold and plastic molding material is injected into the mold to combine the molded article 100 with the sealing layer 50. Accordingly, the edge of the molded article 100 is enclosed by the sealing layer 50.

In FIG. 5, a different sealing layer 64 can be integrally formed with a second layer 62. During the injection molding, the second layer 62 extends to form two branches 642. One branch 642 encloses the periphery of the first layer 10, and the other branch 642 encloses the periphery of the third layer 30.

It is to be understood that the first layer 10 and the third layer 30 both can be made soft material, or both can be made of made of hard material.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A molded article, comprising:
a first layer made of soft material;
a second layer made of plastic material; and
a third layer made of hard material; wherein:
the first layer and the third layer are joined to the opposite sides of the second layer by injection molding.

2. The molded article as claimed in claim 1, wherein the soft material of the first layer is leather and the hard material of the third layer is metal.

3. The molded article as claimed in claim 1, wherein the molded article includes a sealing layer, the sealing layer encloses the edges of the molded article, to prevent separating at the edges thereof.

4. The molded article as claimed in claim 3, wherein the sealing layer is formed integrally with the second layer, the second layer extends to form two branches forming the sealing layer, with one branch enclosing the periphery of the first layer, and the other branch enclosing the periphery of the third layer.

5. The molded article as claimed in claim 3, wherein the sealing layer is formed by a second injection molding step.

6. The molded article as claimed in claim 3, wherein the sealing layer has an L-shaped cross-section, the sealing layer extends to the first layer and covers the end surface of the molded article.

7. A molded article, comprising:
a first layer made of soft material;
a third layer made of hard material;
a second layer made of plastic material and arranged between the first layer and third layer, and
a sealing layer made of plastic material; wherein:
the first layer and the third layer are joined to the opposite sides of the second layer by injection molding, the sealing layer encloses the edges of the molded article to prevent separating at the edges thereof.

8. A method for making a molded article, comprising:
providing a mold, the mold including a male mold and a female mold engaging with the male mold, one of the male mold and the female mold defining a cavity, and the other forming a core engaging with the cavity to form a chamber;
placing a first layer on the core and a third layer into the cavity;
engaging the female mold with the male mold, injecting a plastic material into the chamber, the plastic material combining the first layer and the third layer to form a molded article, the plastic material forming a second layer between the first layer and the third layer; the second layer extending to form a sealing layer, the sealing layer enclosing the edges of the molded article;
opening the mold and taking the molded article out.

9. The method for making the molded article as claimed in claim 8, wherein the first layer is leather and the third layer is metal.

10. The method for making the molded article as claimed in claim 8, wherein the second layer extends to form two branches comprising the sealing layer, with one branch enclosing the periphery of the first layer, and the other branch enclosing the periphery of the third layer.
